(19) United States
(12) Patent Application Publication
(10) Pub. No.: US 2004/0054742 A1
(43) Pub. Date: Mar. 18, 2004

(54) Method and system for detecting malicious activity and virus outbreak in email

(76) Inventors: Shimon Gruper, Kiryat Haim (IL); Ofer Elzam, Kiryat Haim (IL); Dany Margalit, Ramat Gan (IL); Yanki Margalit, Ramat Gan (IL)

Correspondence Address: John F. Letchford, Klehr, Harrision, Harvey, Branzburg & Ellers, 260 South Broad Street, Philadelphia, PA, 19102, US

(21) Appl. No.: 10/463,297

(22) Filed: Jun. 17, 2003

Related U.S. Application Data
(60) Provisional application No. 60/390,184, filed on Jun. 21, 2002.

(51) Int. Cl. G06F 15/16

(52) U.S. Cl. 709/206; 709/249

(57) ABSTRACT

A system and method for detecting the presence of malicious activity within an email junction in which a threshold number for the acceptable email traffic intensity through the email junction is determined, the email traffic intensity in the email junction is monitored, and the presence of malicious activity within the email junction is indicated upon detection of monitored email traffic intensity exceeding the threshold. The invention may also be implemented for other types of data, e.g., files, data packets, and so forth.

### FIELD OF THE INVENTION

The present invention relates to the field of malicious activity detection within email messages.

### BACKGROUND OF THE INVENTION

The more the Internet becomes a popular communication media, the more users use the email services. Therefore, email becomes one of the major propagation channels of computer viruses and other forms of malicious objects.

The most common way of propagating malicious code via email is by attaching a malicious code to email messages. In some cases the user has indication about the attached file, e.g., an icon, thus enabling the user to decide whether to activate the attached executable or not. However in some cases the malicious code is automatically executed the moment the message is opened or even before, when it is previewed (several email software versions enable the user to preview the email message before opening it). For example, when the email message is in HTML format, displaying the message may also cause executing a code (e.g. Java Applet), which may be malicious.

Email client software products enable the user to maintain an address book, which comprises the email address of the correspondents the user uses to communicate with. Also, email clients store selected sent and/or received email messages, which also comprise the email address of the sender, and in the case of additional recipients, their email address too. This pool of email addresses can be used by a malicious object for propagating malicious code. Moreover, since in many cases the recipient whose address has been taken from an address book or an email message is familiar with the sender, he may not suspect that the received email comprises malicious code.

The traditional way of detecting malicious code in email messages is by examining the email at the local level, i.e. testing each message and its supplementary executables, one by one.

The detection of viruses and other forms of malicious objects in a file is carried out in two major ways, virus signature and code analysis, but actually there are many additional methods known in the art for this purpose.

A “Virus signature” is a unique bit pattern that the virus leaves on the infected code. Like a fingerprint, it can be used for detecting and identifying specific viruses. The major drawback of the signature analysis is that the virus should be firstly detected and isolated (by comparing the infected code with the original code). Only then can the signature characteristics be distributed by the anti-virus company among its users.

Another drawback of the signature analysis is that the virus “author” may masquerade the signature by adding non-effective machine language commands between the effective commands. Moreover, the added commands can be selected randomly, thereby generating an unknown signature.

Another way of detecting malicious code within an executable is by analyzing its operation. Since the malicious code is usually added at the end of the executable and the executable is changed such that the first command to be executed will be the added code, indicating such an operation pattern can be an indicator for malicious code. The major drawback of code analysis methods is that it is not a simple procedure and therefore a great deal of effort should be invested until meaningful results are reached. Moreover, a malicious executable which is not a result of an infection is actually a “legitimate” executable and therefore very difficult to be detected as malicious.

At the organization level, it is common to put filtering facilities at the gateway of the organization's local network or at the mail server, thereby enabling the examination of each incoming email message before directing it to the user's mailbox. Actually, according to this solution, the organization is treated as an individual user. An example of such a product is the eSafe Gateway, manufactured and distributed by Aladdin Knowledge Systems (eAladdin.com/esafe). Other organizations filter the viruses only at the users' machines. In this case an infected user, for example, due to not updating his anti-virus program, can cause damage to the whole organization.

Since a filtering facility operating at the organization level operates in the same manner as the filtering facility of the local level, i.e. examines each incoming email messages separately, it has the same drawbacks as a local filtering facility, as described above.

It is therefore an object of the present invention to provide a method and system for detecting malicious activity within email messages, which overcomes the individual virus detection methods.

It is another object of the present invention to provide a method and system for detecting presence of malicious code in an organization, upon which unknown viruses can be detected.

Other objects and advantages of the invention will become apparent as the description proceeds.

### SUMMARY OF THE INVENTION

In one aspect, the present invention is directed to a method for detecting presence of malicious activity within an email junction, comprising: determining a threshold number of the acceptable email traffic intensity through the email junction; monitoring the email traffic intensity in the email junction; and indicating the presence of malicious activity within the email junction upon exceeding the monitored traffic intensity from the threshold.

The email junction may be a gateway between two networks, an email server of an organization, an email client, and so forth. The email traffic intensity may be the incoming email message to the email junction per time unit, the outgoing email message from the email junction per time unit, or any combination between them.

According to one embodiment of the invention, the threshold number is determined according to the normal behavior of the account in a given time. For example, when the user is out on vacation, the threshold number should be adjusted accordingly.

The general case of the present invention is directed to a method for detecting presence of malicious activity within a data junction through which at least one data entity is passing, comprising: determining a threshold number of the acceptable data traffic intensity through the data junction; monitoring the data traffic intensity through the data junction; and indicating the presence of malicious activity within the data junction upon exceeding the monitored traffic intensity from the threshold. Thus, in addition to email messages, the present invention may also be implemented for files, data packets, and so forth.

In another aspect, the present invention is directed to a system for detecting presence of malicious activity within an email junction, comprising: means for storing a threshold number of the acceptable traffic intensity of the email junction, e.g. a memory component; means for monitoring the email traffic intensity of the email junction, e.g., a facility based on software technology or a combination of software and hardware technology; means for storing the current traffic intensity of the email junction, e.g., a memory, port, etc.; and means for detecting whether the traffic intensity of the email junction exceeds beyond the threshold, e.g., a facility based on software technology or a combination of software and hardware technology.

### BRIEF DESCRIPTION OF THE DRAWINGS

The present invention may be better understood in conjunction with the following figures:

FIG. 1 schematically illustrates email delivering and filtering.

FIG. 2 schematically illustrates filtering activity of incoming email to an organization.

FIG. 3 schematically illustrates propagation of an email message in an organization.

FIG. 4 schematically illustrates propagation of an email message in an organization.

FIG. 5 is a high-level flowchart of a method of detecting presence of malicious activity, according to a preferred embodiment of the invention.

FIG. 6 schematically illustrates a system of detecting presence of malicious activity, according to a preferred embodiment of the invention.

### DETAILED DESCRIPTION OF PREFERRED EMBODIMENTS

The term “malicious code” refers herein to all types of software that prevents users from using their computers as they were intended. This includes executables (e.g. Windows EXE files), hostile Java Applets, ActiveX vandals, Trojan horses, scripts, vandals, viruses that are designed to corrupt or steal digital information, and so forth. Consequently, the term “malicious activity” refers herein to any activity of malicious code (including virus outbreak) that is directed to prevent users from using their computers as they were intended.

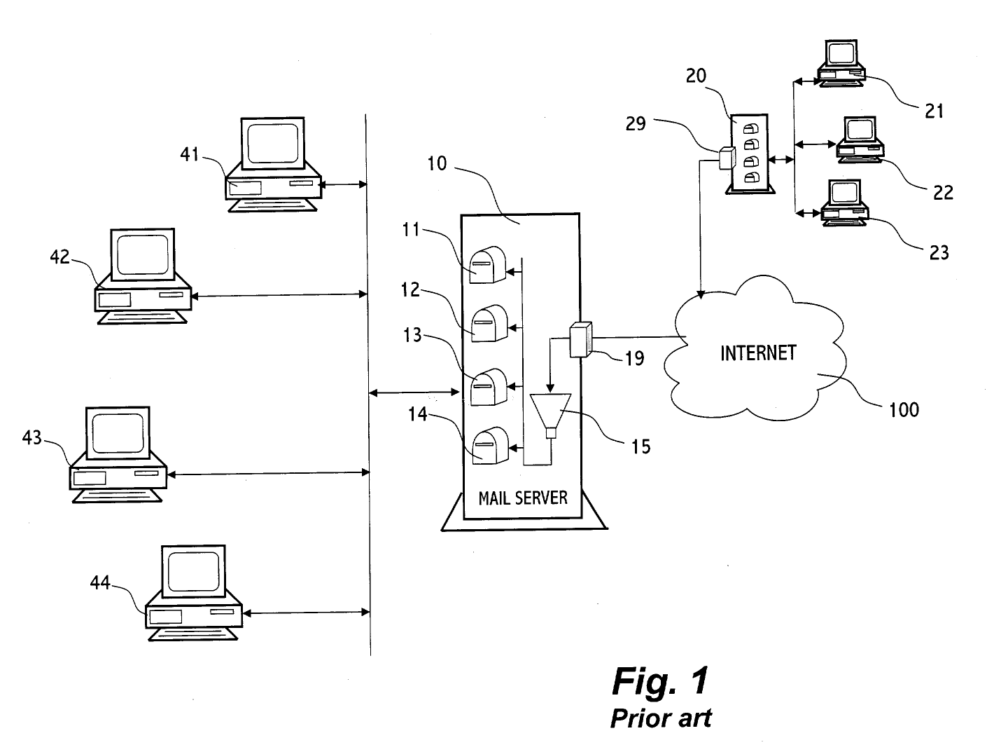

FIG. 1 schematically illustrates email delivering and filtering. A mail server 10 maintains email accounts 11 to 14, which belong to users 41 to 44 respectively. Another mail server 20 serves users 21 to 23. The mail server 10 also comprises an email filtering facility 15, for detecting the presence of malicious code within incoming email messages. A mail server communicates with another mail server by a Mail Transfer Agent (MTA). The MTA can be a part of the mail server or a separate entity. Referring to FIG. 1, mail server 10 is coupled with an MTA 19, by which it communicates with the MTA 29 of mail server 20 through the Internet 100.

An email message sent from, e.g., user 21 to, e.g. user 42, passes through the mail server 20, through the Internet 100, until it reaches to mail server 10. At the mail server 10 the email message is scanned by the filtering facility 15, and if no malicious code is detected, then it is stored in email box 12, which belongs to user 42. The next time user 42 opens his mailbox 12 he finds there the delivered email message.

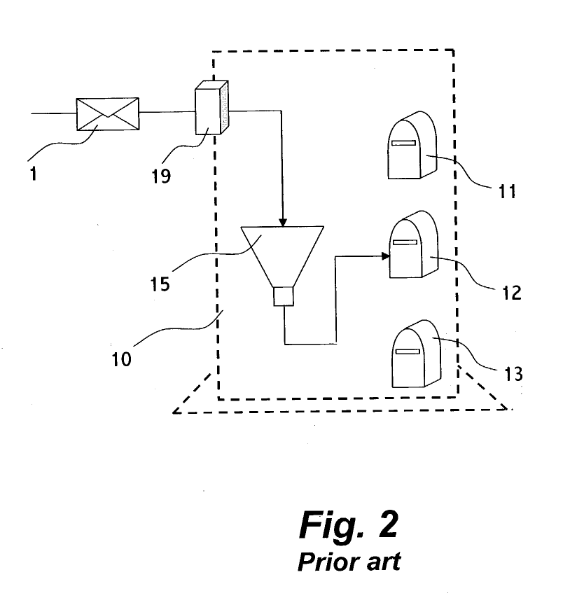

FIG. 2 schematically illustrates filtering activity of incoming email to an organization. An email message 1 that arrives to the mail server 10 of the organization is scanned by the filtering facility 15. If no malicious code is found within the email message 1, then the email message is delivered to the appropriate email client within the organization, otherwise an appropriate message is sent to the recipient, e.g. as an email message. Of course instead of or in addition to notifying the recipient about the found malicious code, the filtering facility 15 may remove the malicious files from the email message, or eliminate the malicious code from the files.

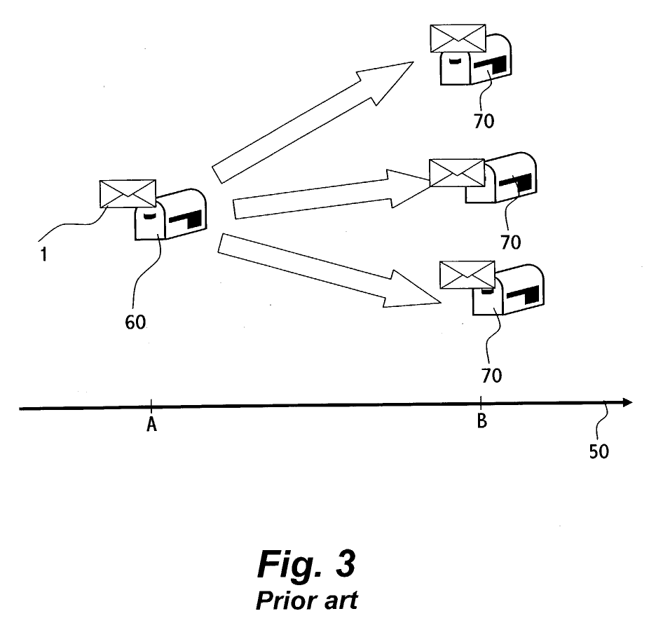

FIG. 3 schematically illustrates propagation of an email message in an organization. A and B are points on the time axis 50, such that B is greater than A. An email message 1 that comes in to the email box 60 at time A is propagated to the email boxes 70, whereto it arrives at time B. The propagation can be characterized by at least the time required for the propagation, and/or the quantity of the propagated email messages.

For example, one minute after an email message reaches the mailbox of a user, fifty email messages are sent from his mailbox to other recipients within the organization. Indeed, such a situation can happen, since the user may send another email message to fifty recipients without any regard for the arrived email message. However, if an email message that arrives to the user is forwarded within one minute since it arrives in a mailbox to fifty recipients, it may indicate the possibility of presence of a malicious activity.

A common feature in email systems is the possibility to define groups of users. Once a group is defined, a user may send an email message to the group. Thus, whenever the mailing system supports such a feature, sending tens or more email messages is reasonable. However, sending tens or more email messages a short period after an email message arrives to this account is suspicious.

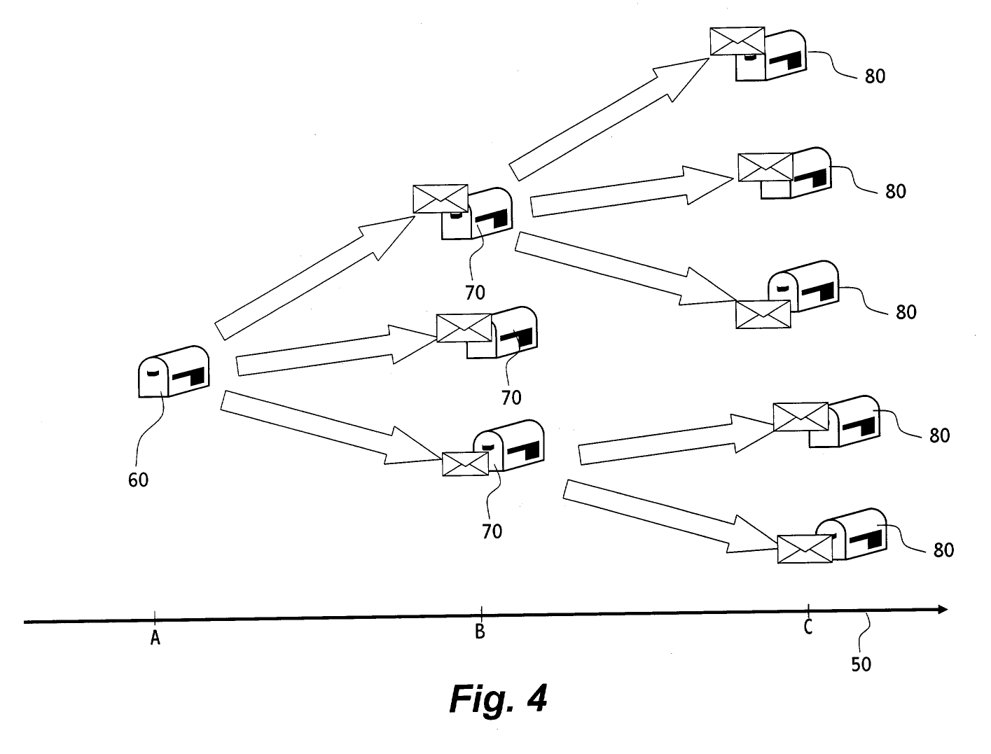

FIG. 4 schematically illustrates propagation of an email message in an organization. Email messages sent from email boxes 60 at time A is propagated to the email boxes 70, whereto it arrives at time B, and from there to email boxes 80, whereto it arrives at time C. Since each email box sends a plurality of email messages, the quantity of the posted messages during the period between time-marks A and C is more than expected during a normal behavior of the email system at the organization.

In order to facilitate the reading of the present document, the following terms are defined:

The term email “junction” refers herein to a point through which email messages are passing, e.g. a mail server, a gateway between two networks, and so forth.

The term “passing” email messages refers herein to the incoming email messages to an email junction, outgoing email messages from an email junction, or any combination between them, such as the difference between the number of outgoing and incoming email messages through an email junction.

The term email “traffic intensity” refers herein to the number of email messages passing through an email junction per a time unit.

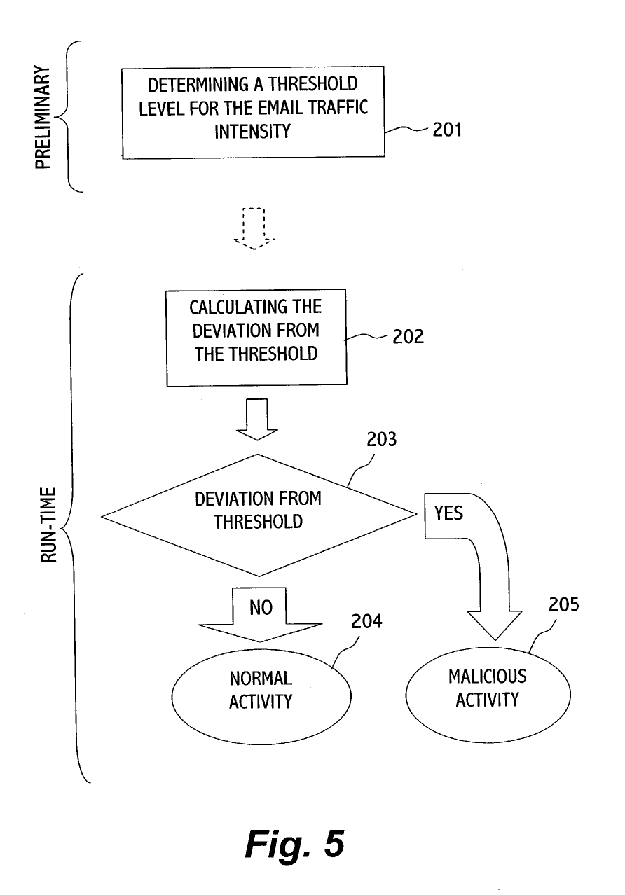

FIG. 5 is a high-level flowchart of a method of detecting presence of malicious activity, according to a preferred embodiment of the invention.

At step 201, which is a preliminary stage, a threshold of the traffic intensity of an email junction is determined. The threshold number can be amended later during the “run-time”. For example, whenever an employee is on vacation, he sets his email account to respond with an “out of office” message. Thus, at this period it is expected that the number of the incoming and outgoing messages during a time unit will be about the same. However, if during one minute 5 email messages have been received, and 30 have been sent, it may indicate the presence of malicious activity.

At step 202, which is performed during the run-time, the deviation of the email traffic intensity from said threshold is calculated.

Typically, such an activity is carried out at the mail server, which concentrates the mail activity of the organization. Each email message has some information fields, which can be used for calculating the traffic intensity on the organization level as well as on the user level.

Usually, the relevant information is the recent information, such as the difference between the number of outgoing email messages from the account and incoming email messages to the account during the last two minutes. However, information regarding a longer period, e.g. one week, can also indicate about malicious activity, since a smart malicious code can send malicious email messages not necessarily immediately, but later on.

At step 203, if a deviation from said threshold is indicated, then the presence of malicious activity within the email junction is determined (marked as 205), otherwise a normal behavior is determined (marked as 204).

According to a preferred embodiment of the invention, the email messages are delayed at the email junction for a short period, thereby enabling to abort sending the mail if a malicious activity has been indicated and consequently preventing the damage thereof. Practically, since the action of posting an email message from a sender to a recipient within an organization means just changing some fields at the email database of the mail server, postponing the transfer of such an email message means postponing the operation of changing flags and/or other related information.

Whenever a suspicion of malicious activity is indicated, an alert procedure can be activated, e.g., notifying the system administrator, suspending the operation of the mail server, etc.

Monitoring the incoming and outgoing email messages can be carried out at the mail server(s) of the organization, since this is a junction in the email path within the organization, as well as from/to outside the organization. However, such an activity can also be carried out at the gateway to the network(s) of the organization. Actually, the place where the email messages can be monitored depends on the network architecture.

As per the user level, monitoring the traffic intensity can be carried out at the user's machine, and the results may be reported to a central facility which concentrates this activity.

The invention may be implemented as a system comprising at least the following elements:

Means for storing a threshold number of acceptable traffic intensity of an email junction, e.g. volatile memory elements, non-volatile memory elements, and so forth.

Means for monitoring the email traffic intensity of the email junction, e.g. a facility based on software/hardware technology.

Means for storing the current traffic intensity, e.g. a memory element.

Means for detecting whether the current traffic intensity of said email junction exceeds beyond said threshold, e.g. a facility based on software/hardware technology.

Of course the facility detects whether the traffic intensity of said email junction should be able to access the memory which stores the threshold number and memory which stores the current traffic intensity of the junction.

The invention may also be implemented for other types of data traffic. For example, a malicious code which has been activated on the user's machine may send to the sharable folder of other users connected to the same network a malicious executable. The malicious executable cannot make any damage to the destination computer, unless it is activated by the destination computer. This can be carried out, for example, by replacing the Autoexec facility (i.e. the script performed when a computer boots) of the destination computer to execute the malicious code.

Thus, in conjunction with the general case, the following terms are defined:

The term data “junction” refers to a point through which data entities (e.g. files, data packets, email messages, and so forth) are passing.

The term “passing” data entities refers herein to the incoming data entities to a data junction, outgoing data entities from said data junction, or any combination between them, such as the difference between the number of outgoing and incoming data entities.

The term “data traffic intensity” refers herein to the number of data entities passing through a data junction per a time unit.

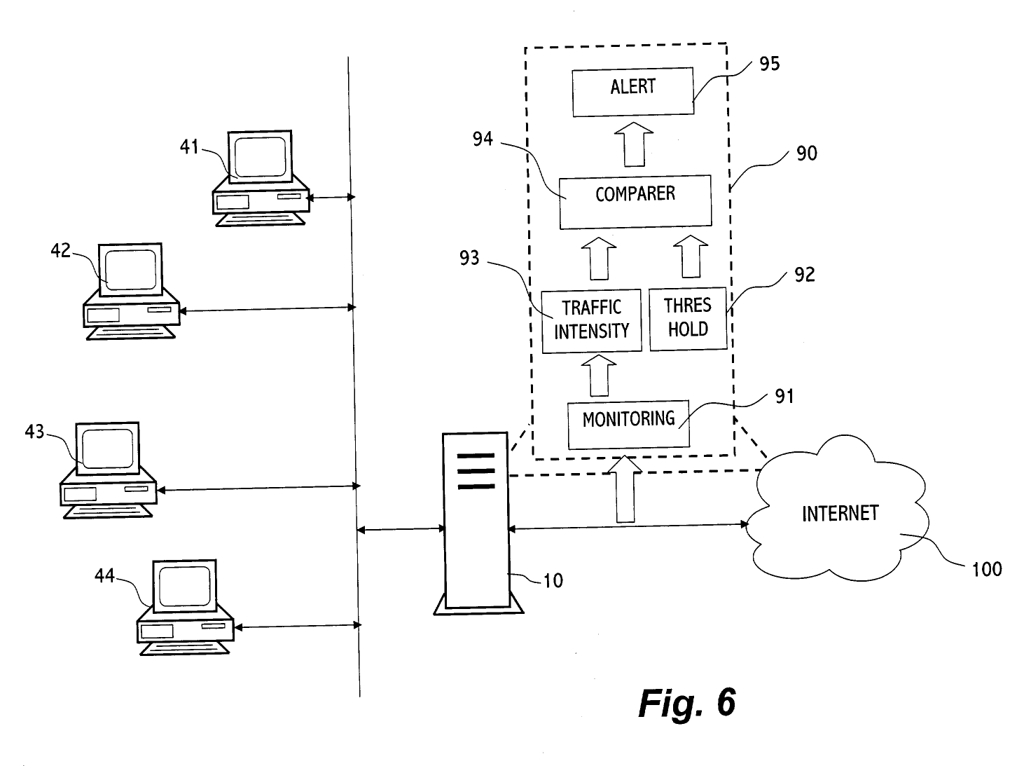

FIG. 6 schematically illustrates a system of detecting presence of malicious activity, according to a preferred embodiment of the invention. The system may be implemented via a computerized facility 90. The system comprises:

A monitoring facility 91, for monitoring the email traffic intensity through an email junction. At the illustration of FIG. 6 the email junction is a point that connects between the Internet 100 and the email server 10. A monitoring facility deployed between two network points (i.e. email junction) comprises software and hardware means, however the monitoring facility may be a part of the email sever, and consequently may comprise only software means.

A threshold carrier 92, for storing a threshold value of the acceptable traffic intensity of said email junction, e.g. a memory component. Of course the threshold value can be stored on a non-volatile storage means, like hard disk, and later loaded into the threshold carrier. Setting the value within the threshold carrier can be carried out by a software module, etc.

A traffic intensity carrier 93, which for example may be a memory component, a port, etc. The traffic intensity value is provided by the monitoring facility 91, and therefore the traffic intensity carrier 93 should be accessible by the monitoring facility 91.

A comparer 94, which compares the current traffic intensity (stored within the traffic intensity carrier 93) with the allowed threshold number (stored within the threshold carrier 92). The comparer 94 should be able to retrieve the values stored within the threshold carrier 91 and the current traffic intensity 92.

An alerting facility 95, which alerts the system operator in case where the current traffic intensity passes beyond the allowed traffic intensity. The alert can be, e.g. by sending an email message to the system operator, an alarm, a voice message sent to the cell phone of the system, operator, and so forth. The alerting facility 95 may also instruct the email server 10 to suspend delivery of email messages, etc., whereby to prevent damage due to malicious activity.

Those skilled in the art will appreciate that the invention can be embodied by other forms and ways, without losing the scope of the invention. The embodiments described herein should be considered as illustrative and not restrictive.

1. A method for detecting presence of malicious activity within an email junction, comprising:
determining a threshold number of the acceptable email traffic intensity through said email junction;
monitoring the email traffic intensity in said email junction; and
indicating the presence of malicious activity within said email junction upon exceeding the monitored traffic intensity from said threshold.

2. A method according to claim 1, wherein said email junction is selected from the group comprising a gateway between two networks, an email server of an organization, and an email client.

3. A method according to claim 1, wherein said email traffic intensity is selected from the group comprising the incoming email messages to said email junction per time unit, the outgoing email messages from said email junction per time unit, and any combination between the incoming email messages to said email junction and the outgoing email messages from said email junction per time unit.

4. A method according to claim 1, wherein said threshold number is determined according to the normal behavior of said account in a given time.

5. A method according to claim 1, further comprising postponing the transfer of email messages, until indicating that no malicious activity is carried out with respect to said email junction.

6. A method according to claim 1, further comprising upon detecting presence of malicious activity within said email junction, performing an operation selected from the group comprising alerting about the presence of malicious activity within said email junction, suspending sending of email messages, aborting sending of email messages, and erasing at least one recently delivered email message from its corresponding email account.

7. A method for detecting presence of malicious activity within a data junction through which at least one data entity is passing, comprising:
determining a threshold number of the acceptable data traffic intensity through said data junction;
monitoring the data traffic intensity through said data junction; and
indicating the presence of malicious activity within said data junction upon exceeding the monitored traffic intensity from said threshold.

8. A method according to claim 7, wherein said at least one data entity is selected from the group comprising an email message, a file, and a data packet.

9. A method according to claim 7, wherein said data junction is selected from the group comprising an email account, an email client, an email server, and the gateway between two networks.

10. A system for detecting presence of malicious activity within an email junction, comprising:
means for storing a threshold number of the acceptable traffic intensity of said email junction;
means for monitoring the email traffic intensity of said email junction;
means for storing the monitored traffic intensity of said email junction; and
means for detecting whether the traffic intensity of said email junction exceeds said threshold.

11. A system according to claim 10, wherein said means for storing a threshold number and said means for storing the monitored traffic intensity are accessible by said means for detecting whether the traffic intensity of said email junction exceeds said threshold number.

12. A system according to claim 10, wherein said means for storing a threshold number is a memory component selected from a group comprising volatile and non-volatile memory.

13. A system according to claim 10, further comprising means for performing operations selected from the group comprising alerting about the presence of malicious activity within said email junction, suspending sending of email messages, aborting sending of email messages, and erasing at least one recently delivered email message from its corresponding email account.

14. A system according to claim 10, wherein said means for monitoring the email traffic is based on a combination of software and hardware technology.

15. A system according to claim 10, wherein said means for detecting whether the traffic intensity of said email junction exceeds said threshold number is based on a combination of software and hardware technology.
